(19) United States
(12) Patent Application Publication
(10) Pub. No.: US 2012/0315017 A1
(43) Pub. Date: Dec. 13, 2012

(54) CONTENT LIST AND CONTENT DELIVERY APPARATUS AND METHOD

(76) Inventors: Takaki MATSUSHITA, Yokohama (JP); Chiyo Ohno, Chigasaki (JP)

(21) Appl. No.: 13/487,466

(22) Filed: Jun. 4, 2012

(30) Foreign Application Priority Data
Jun. 8, 2011 (JP) 2011-127839

(51) Int. Cl. H04N 5/85

(52) U.S. Cl. 386/252; 386/E05.064

(57) ABSTRACT

A technique for achieving secure content distribution with increased copyright protection is disclosed. A content delivery apparatus is network connected to in-home/out-home content reproducible receiver devices, including digital TV sets, mobile phones or the like. The content delivery apparatus includes an optical disk drive, a built-in large capacity storage, a content list transmission unit responsive to receipt of a content list acquisition request from a content receiver device, for transmitting a list of contents recorded on an optical disk loaded in the optical drive and stored in the storage, and a content transmission unit responsive to a content and storage and for delivering it to the receiver. In cases where the content demanded is on the optical disk, if the receiver is currently outside an architectural structure with the apparatus installed therein, the content delivery to such receiver is prevented.

### INCORPORATION BY REFERENCE

The present application claims priority from Japanese application JP2011-127839 filed on Jun. 8, 2011, the content of which is hereby incorporated by reference into this application.

### BACKGROUND OF THE INVENTION

The present invention relates generally to content distribution network technologies, and more particularly to apparatus and methodology for delivering over a network a content list and contents recorded on an optical disk and stored in a record media other than the optical disk.

With recent advances in digital video signal processing technology, various types of digital audio-visual (AV) equipment have been made commercially available in succession, such as digital tuners for reception of digital broadcasting programs, digital television (DTV) sets with digital tuners built therein, digital video recording devices for recording and replaying digital broadcast programs (e.g., hard disk drive (HDD) recorders, digital versatile disc (DVD) recorders, and Blu-ray disc (BD) recorders), and network-attached storage (NAS) devices.

In addition, with expanded use of broadband/Internet technology, PCs and digital AV devices are designed to have digital interfaces, such as wired or wireless local area network (LAN), IEEE1394, universal serial bus (USB), high definition multimedia interface (HDMI) and so forth, thereby enabling transmission of digital contents over a network in both in-home and out-home environments. Especially, the digital living network alliance (DLNA) becomes widespread as the guidelines for performing digital content sharing by using an in-house established network. Today, many DLNA-compliant AV equipment products including PCs have been commercially released in the market.

When transmitting digital content between digital AV devices, copy protection is carried out to prevent unlimited duplication in a way which follows: encryption is performed on the side of a content sender device so as to perform the sharing of information for decryption between it and a content receiver device to thereby ensure that the content is correctly received and cannot be decoded by those devices other than the content receiver acting as a destination device.

One example of such the copy protection method, which is currently employed in digital AV devices, is a technique as disclosed in JP-A-2005-269288. With this technique, contents are classified for management into “Copy free (copy-capable with no limits),” “Copy free with EPN asserted (unlimitedly copiable with output protection added thereto),” “Copy one generation (only one generation is copiable),” “No more copies (re-copying is prevented)” and “Copy never (copy is prevented),” wherein a recorder device is allowed to record only those contents of the “Copy free,” “Copy free with EPN asserted” and “Copy one generation” and is designed to handle once-recorded contents of “Copy one generation” as “No more copies”; on network/bus, those contents excluding the “Copy free” are transferred with encryption processing applied thereto on the sender side to thereby ensure that unlimited content duplication is not executable in any way.

JP-A-2010-119137 discloses therein a technique for enhancing the copyright protection of contents during transmission of the contents between devices.

On the other hand, video/audio contents such as motion pictures and music or else are widely distributed in the form of being recorded on optical disks, such as BDs, DVDs, compact discs (CDs) and so forth. In cases where copyright-protected contents are recorded on optical disks, copy protection techniques used therefor include digital rights management (DRM) schemes, such as advanced access content system (AACS), content scramble system (CSS), content protection recordable media (CPRM), etc.

### SUMMARY OF INVENTION

The techniques of the above-cited JP-A-2005-269288 and JP-A-2010-119137 are inventions for enhancing the copyright protection in the event of sending copyright-protected contents over a distribution network. However, these Japanese patent literatures fail to take into consideration the case of copyrighted contents being recorded on optical disks, resulting in the risk of losing an ability to perform secure content delivery and reliable copyright protection.

It is, therefore, an object of the present invention to realize implementation of stable content delivery and reliable copyright protection in an environment that a content delivery apparatus which has a built-in optical disk drive that treats record media, such as BDs, DVDs or CDs, or which is able to utilize external optical disk drive is connected via a network to content-reproducible player devices existing at indoor or outdoor locations, such as cellular telephone handsets, TV sets and other similar devices.

To attain the object, this invention employs arrangements as recited in the appended claims. This invention includes a plurality of means for solving the problem, one of which is as follows: a content list and content delivery apparatus for sending a content list and contents over a network includes an optical disk device capable of reproducing the contents, a record media capable of recording the contents, the record media excluding optical disks, a content list generation/transmission device responsive to receipt of a content list acquisition request to be sent from a content receiver device connected via the network, for generating and transmitting a list of contents recorded on an optical disk being set in the optical disk device and also in the record media other than the optical disk, and a content delivery device responsive to receipt of a content delivery request to be sent from the content receiver device, for searching a corresponding content from within the optical disk being set in the optical disk device and the record media other than the optical disk and for delivering it to the content receiver device, wherein upon receipt of the content delivery request as sent from the content receiver device, in cases where the content requested is a content recorded on the optical disk and, simultaneously, the content receiver device does not exist in the same building as that of the content delivery apparatus, content delivery responding to the content delivery request is not performed.

In accordance with this invention, it is possible to achieve improvement of the stability in network distribution of those contents recorded on the optical disk of the content delivery apparatus. It is also possible to reliably protect the right of an owner of copyright of such contents. These and other objects, features and advantages of the invention will be apparent from the following more particular description of currently preferred embodiments of the invention, as illustrated in the accompanying drawings.

Other objects, features and advantages of the invention will become apparent from the following description of the embodiments of the invention taken in conjunction with the accompanying drawings.

### BRIEF DESCRIPTION OF DRAWINGS

FIG. 1 is a diagram schematically showing an embodiment of this invention.

FIG. 2 is a system configuration diagram showing an embodiment of this invention.

FIG. 3 is a flow chart showing an embodiment of a content delivery apparatus.

FIG. 4 is a flowchart showing an embodiment of the content delivery apparatus.

FIG. 5 is a pictorial representation of an on-screen display example in an embodiment of a content receiver device.

FIG. 6 is a flowchart showing an embodiment of the content delivery apparatus.

FIG. 7 is a pictorial representation of an on-screen display example in an embodiment of the content receiver device.

FIG. 8 is a flowchart showing an embodiment of the content delivery apparatus.

FIG. 9 is a flowchart showing an embodiment of the content delivery apparatus.

FIG. 10 is a flowchart showing an embodiment of the content delivery apparatus.

FIG. 11 is a flowchart showing an embodiment of the content delivery apparatus.

FIG. 12 is a diagram schematically showing an embodiment of this invention.

FIG. 13 is a flowchart showing an embodiment of a content delivery apparatus.

FIG. 14 is a flowchart showing an embodiment of the content delivery apparatus.

FIG. 15 is a configuration diagram showing an embodiment of the content delivery apparatus.

FIG. 16 is a configuration diagram showing an embodiment of content receiver device.

### DESCRIPTION OF EMBODIMENTS

Currently preferred embodiments of this invention will be set forth below.

### Embodiment 1

This embodiment is an example in which content reception devices, such as TV sets or PCs, receive for users' audio-visual entertainment those contents to be sent from a content delivery apparatus via a distribution network.

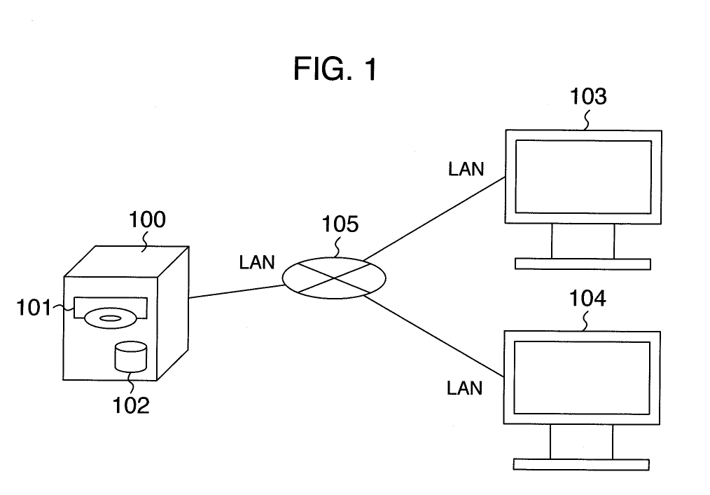

FIG. 1 shows an entire system configuration of this embodiment. As shown herein, a content distribution/delivery apparatus 100 is arranged to have an optical disk drive (ODD) 101 and built-in record media 102, and is communicable with TVs 103 and 104, which are content receiver devices, via a local area network (LAN) 105.

The content delivery apparatus 100 sends for distribution those contents which are recorded on an optical disk that is presently loaded into the ODD 101 and also stored in the built-in record media 102 toward content receiver devices 103 and 104 via the network. Meanwhile, the content receiver devices 103-104 are information equipments which require the content delivery apparatus 100 to deliver playback contents and reproduce the contents received from the content delivery apparatus 100.

The LAN 105 is arranged to use the Internet protocol (IP) standardized as the network protocol and use, for upper-level transport protocols, the transmission control protocol (TCP) and user datagram protocol (UDP). For content transmission, further upper-level application protocols are used, including but not limited to the real-time transport protocol (RTP), hypertext transfer protocol (HTTP) and file transfer protocol (FTP). It should be noted that IP has different versions, IPv4 and IPv6, either one of which is employable on a case-by-case basis. Each device may alternatively be connected via a hub and router by means of the LAN, although these components are not depicted in FIG. 1.

The content delivery apparatus 100 sends the contents recorded on the optical disk being loaded into ODD 101 toward the content receiver devices 103 and 104 which are linked via the network. In cases where the contents to be sent are contents under copyright protection, the digital transmission content protection over Internet protocol (DTCP-IP) is used for prevention of unauthorized copy and falsification on the network.

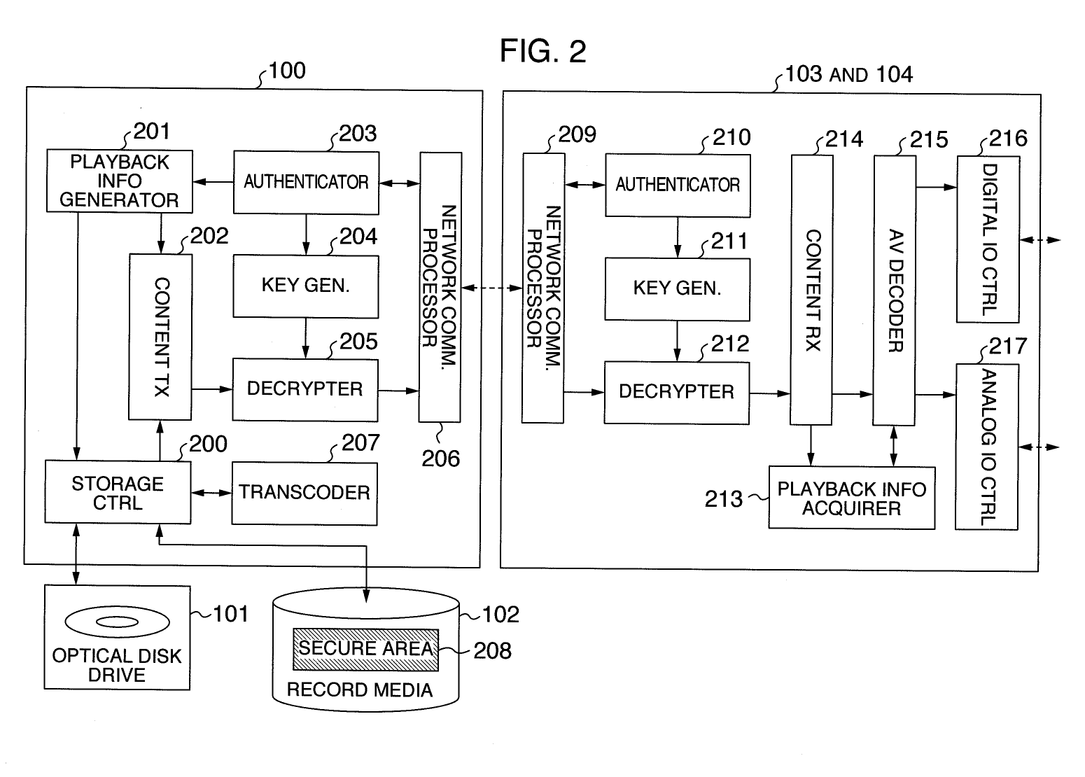

FIG. 2 is a block diagram for explanation of internal configurations of the content delivery apparatus 100 and the content receiver devices 103 and 104 in this embodiment.

The content delivery apparatus 100 has ODD 101 and built-in record media 102 and also has a storage control unit 200, playback information generation unit 201, content sending unit 202, authentication unit 203, key generation unit 204, encryption unit 205, network communication processing unit 206, and transcode processing unit 207. The built-in record media 102 has therein a secure storage area 208, which is externally inaccessible from users.

The storage control unit 200 is interconnected to the ODD 101 and record media 102, for reading video/audio data recorded on an optical disk loaded into ODD 101 and stored in the record media 102 along with management information of such video/audio data. In cases where the video/audio data are copyright-protected contents and simultaneously the data encrypted by AACS, CPRM, CSS or else, the storage control unit 200 reads any one of the contents while applying decryption thereto on a real-time basis. In addition, the storage control unit 200 sends forth the management information thus read toward the playback information generator unit 201 and sends the content to the content sender unit 202. The management information contains therein video/audio data type-specifying information (e.g., IFO file) and information concerning scenes and title of the video/audio data (e.g., clip information file and play-list file).

The playback information generator unit 201 converts the management information read out of the storage control unit 200 into a format designated by the DLNA or DTCP-IP. For example, in order to allow the content delivery apparatus 100 to transmit a content list and other additional information items to the content receiver device(s) 103, 104 in a way to be later described, certain information contained in the above-stated management information, such as a content name, format, time-and-date, etc., is converted into the DLNA-compliant format. Additionally, copy control information of each content item (such as “Copy never,” “Copy one generation,” a predefined number of times of permissive copying sessions, etc.) is converted to the DLNA- or DTCP-LP-compliant form. By doing transmission and reception of content using the DTCP-IP, it is possible to perform the data transmission/reception while preventing illegal copy/duplication. This in turn makes it possible to transfer the content recorded on the optical disk loaded into ODD 101 to other terminals without suffering from the risk of illegal duplication, thereby enabling protection of the right of an owner of the copyright to the content.

The content sender unit 202 transmits video/audio data of the content acquired from the storage control unit 200 to the encryption unit 205 while letting the data have an arrangement complied with the DTCP-IP standard. Where necessary, the management information to be sent from the playback information generator unit 201 may also be sent to the encrypter unit 205.

The authentication unit 203 is connected to the playback information generator unit 201, key generator unit 204 and network communication processor unit 206. The authenticator 203 operates, for transmission of copyright-protected content via the network, to perform mutual authentication of whether its associated other AV devices (i.e., content receiver devices 103 and 104) are truly authorized devices or not by using a specific authentication protocol (in this embodiment, the DTCP-IP standard-complied protocol) utilized therebetween and, if so, then share a key for use in encryption and decryption of the content. Here, the information necessary for the authentication protocol is obtainable from the key generator 204.

The key generator 204 generates key information needed for the content encryption based on the key shared by the authenticator unit 203.

The encrypter 205 is connected to the content transmitter 202, key generator 204 and network communication processor 206. The encrypter 205 uses the key information of key generator 204 to perform content encryption processing.

The network communication processor 206 is arranged to mount communication protocol stacks, such as HTTP/RTP/TCP/UDP/IP, and send the content with various kinds of protocol headers added to transmission data toward other network-linked equipments (here, the content receiver devices 103 and 104) and transfer thereto other management information items when the need arises. It also sends data required for the authentication with the content receiver devices 103-104.

The transcode processor 207 decodes the content data as read out of storage controller 200 and converts the data to pixel value data of a digital video signal. Subsequently, it encodes the pixel value data by using a coding scheme different from that of the original content. Examples of the coding scheme include the motion picture experts group 2 (MPEG2), H.264/MPEG4, advanced video coding (AVC), etc.

The secure area 208 is an encrypted storage area which is not accessible from users and any software other than an exclusive-use software program (such as an application or driver). In FIG. 2, the secure area 208 exists as a separate or “isolated” area within the built-in record media 102, although not necessarily provided within the record media 102. This secure area may also be provided as a separate partition of the built-in record media 102 or may alternatively be constituted from another record media which is different from the record media 102. It is noted that the secure area 208 is a storage media excluding optical disks; for example, a hard disk drive (HDD), information versatile disk for removable usage (iVDR), solid-state drive (SSD), flash memory or the like is employable. The content receiver devices 103-104 are each arranged to have a network communication processing unit 209, authentication unit 210, key generation unit 211, decryption unit 212, playback information acquisition unit 213, content receiver unit 214, video/audio decoder 215, digital input/output control unit 216 and analog input/output control unit 217.

The network communication processor 209 is linked via LAN to the content delivery apparatus 100. The network communication processor 209 has communication protocol stacks mounted therein, such as HTTP/RTP/TCP/UDP/IP, and operates to remove headers of various protocols being added to the data received from the content delivery apparatus 100 and then sends contents and other management information items toward the decrypter 212. It also sends and receives data necessary for authentication with the content delivery apparatus 100.

The authentication unit 210 is linked to the network communication processor 209 and key generator 211. The authenticator 210 performs mutual authentication of whether its associated AV device (i.e., content delivery apparatus 100) is truly authorized equipment or not by using specific authentication protocol (in this embodiment, the DTCP-IP standard-complied protocol) utilized therebetween and, if so, then shares the key for use in encryption and decryption of content. Here, the information needed for the authentication is obtainable from the key generator 211.

The key generator 211 generates the key information needed for the content decryption based on the key shared by the authenticator 210.

The decrypter 212 is connected to the content receiver 214. The decrypter 212 uses the key information of key generator 211 to perform decryption processing of the content.

The playback information acquisition unit 213 receives from the content receiver 214 the playback information that was generated by the playback information generator 201 of content delivery apparatus 100, and controls reproduction of such data based on the playback information in cooperation with the video/audio decoder 215 in a way to be later described.

The content receiver 214 extracts superimposed playback information from the content that was received from the decrypter 212 and then transmits it to the playback information acquisition unit 213. The content per se is sent to the video/audio decoder 215.

The video/audio decoder 215 decodes contents which are coded into respective moving-picture formats, such as MPEG2, H.264/MPEG4, and AVC or the like, and sends decode results to either the digital input/output control unit 216 or the analog input/output controller 217.

The digital I/O controller 216 outputs digital data decoded by the video/audio decoder 215 to a display device. For electrical connection with this display device, digital data inputtable/outputtable cable and terminal are used, such as HDML digital visual interface (DVI) or else.

The analog IO controller 217 performs digital-to-analog conversion to thereby convert digital data decoded by the AV decoder 215 into analog information, and then outputs it to the display device. For connection with the display device, analog information inputtable/outputtable cable and terminal are used, such as RCA plug, D plug, etc.

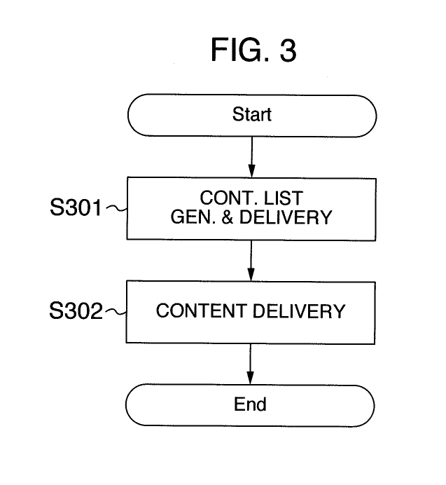

The optical disk to be loaded into ODD 101, e.g., DVD or BD, is assumed to record thereon contents, such as movies, broadcast programs and Internet-distributed entertainment programs, information as to such contents, and software programs. The built-in record media 102 may be any one of various kinds of recording media other than DVDs and BDs, such as SD cards, HDD and semiconductor memory devices, which store therein video/audio contents, video contents, audio contents, still pictures, PC-produced document files, and various kinds of software programs. Here, one embodiment showing characteristic features of this invention will be explained using FIGS. 3 to 7. Note that the explanation of this embodiment to be given below uses the content receiver device 103, although similar results are obtainable even when using other types of AV devices including the content receiver device 104.

FIG. 3 is a flowchart of the processing covering up to network distribution of one of the contents stored in the content delivery apparatus 100.

Upon receipt of a content acquisition request from network-linked AV device (e.g., content receiver device 103) via the network communication processor unit 206, the content delivery apparatus 100 uses the storage controller 200 to collect information as to the contents that are recorded on the optical disk loaded into ODD 101 and contents stored in the built-in record media 102 (e.g., content titles, recording format, capacity, content-acquirable uniform resource locators (URLs), port numbers, flags indicating whether contents are copyright-protected or not, authentication execution port number, etc.) and then generates a content list. This content list is sent via the network to the content receiver device 103 that is a source of request (at step S301).

Subsequently, upon receipt of a content delivery request from the content receiver device 103 via the network, the content delivery apparatus 100 analyzes content information included in the content delivery request and searches both the optical disk loaded in ODD 101 and the built-in record media 102 for the content demanded. Then, it reads the demanded content by means of the storage controller 200, which content is sent by the content transmitter 202 to the content receiver device 103 that is the source of request by way of the network communication processor 206.

Note here that in a case where the demanded content is a copyright-protected content, the authenticator 203 is used to execute prespecified authentication processing between it and the content receiver device 103, and shares key information between with the content receiver device 103 only when the authentication processing was succeeded. Then, the key generator 204 is used to generate an encryption key for encryption of the content based on the shared key information. Next, the encrypter 207 uses the encryption key to encrypt the content read by the storage controller 200, followed by transmission of the encrypted content after having added thereto a predetermined header (e.g., copy control information, such as “Copy never” or “No more copies,” information relating to a data length, the encryption key, etc.) when the need arises. The timing for execution of the above-stated authentication processing is as follows: in case a result of judgment as to whether a desired content chosen from within the content list received by the content receiver device 103 at step S301 is under copyright protection indicates that the content is a copyright-protected object, the authentication processing may be carried out between the content receiver device 103 and content delivery apparatus 100 before issuance of the content delivery request to be sent to the content delivery apparatus 100 at step S302.

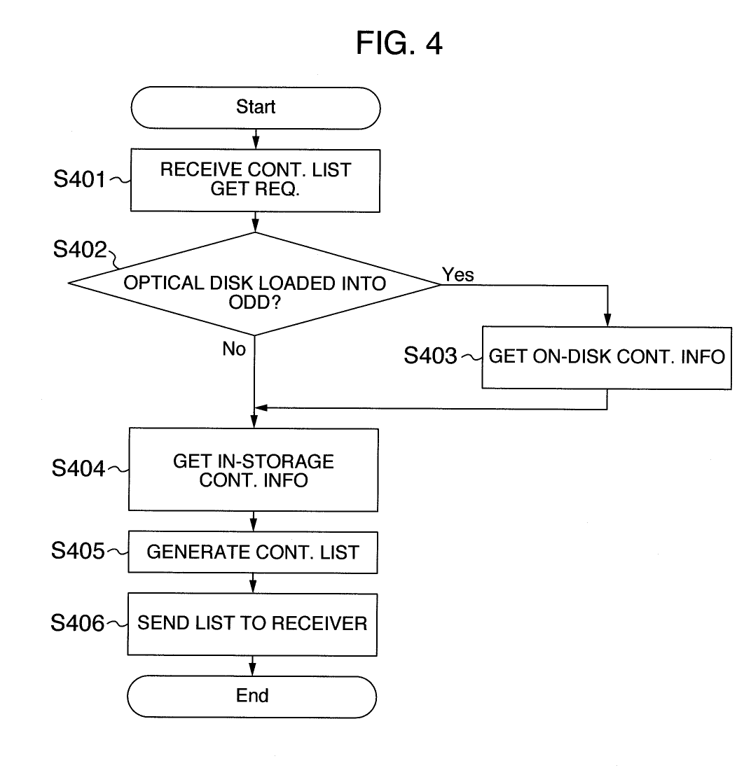

FIG. 4 is a flowchart for detailed explanation of the content list generation/distribution processing of the step S301 of FIG. 3.

The content delivery apparatus 100 receives a content list acquisition request from the content receiver device 103 via the network (at step S401).

Next, investigation is made to determine whether an optical disk is loaded into the optical disk drive (ODD) 101 (at step S402).

As a result of the step S402, when it is determined that any optical disk is not loaded into ODD 101, the system procedure goes to step S404.

When the result of step S402 indicates that an optical disk is loaded into ODD 101, the procedure goes to step S403 which collects information concerning the contents recorded on the optical disk loaded in ODD 101. The information concerning the contents refers to information required for generation of a content list, such as file names of the contents, video formats of the contents, play time of each content, etc.

Next, an operation is done to collect information as to the contents stored in the built-in record media 102 (at step S404).

Then, the information collected at steps S403 and S404 is used to generate a list of contents (at step S405).

Lastly, the content list is sent to the content receiver device 103 (at step S406). By performing at the step S403 acquisition of the information as to the contents recorded on the optical disk and transmission of the content list with the optical disk content information included therein to the content receiver device, the user is able to demand and receive for audiovisual enjoyment his or her favorite optical-disk content from the content receiver device.

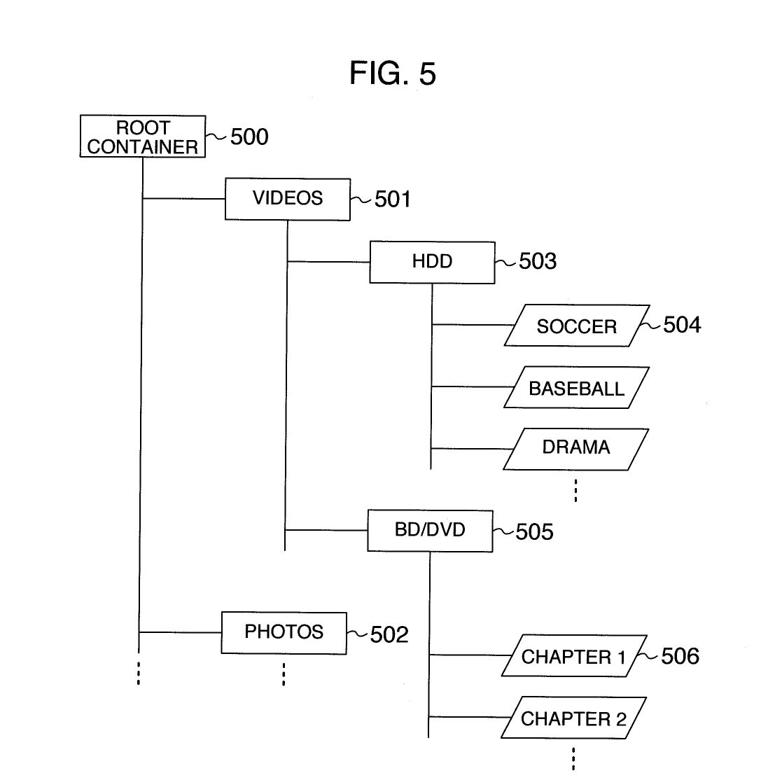

FIG. 5 shows one exemplary content selection menu screen used in the content receiver device 103. The content receiver device receives the content list from the content delivery apparatus and creates a content selection screen image, which will be displayed to the user. In an under-layer of a root container 500, there are containers which categorized by content kinds, such as video 500, photograph 502 and others. Furthermore, in an underlayer of the video 501, there are displayed containers that are classified by the record/storage media within content delivery apparatus, such as HDD 503 and BD/DVD 505, for example. In an underlayer of the HDD 503 and BD/DVD 505, there are displayed character strings indicative of contents per se, such as content names, file names, etc. For example, icons named the “Soccer” 504 and “Chapter #1” 506 are displayed to the user. The user is able to demand and enjoy digital entertainment by using an input device of the content receiver device to select his or her preferred content (e.g., Soccer 504 or Chapter #1 506 or else).

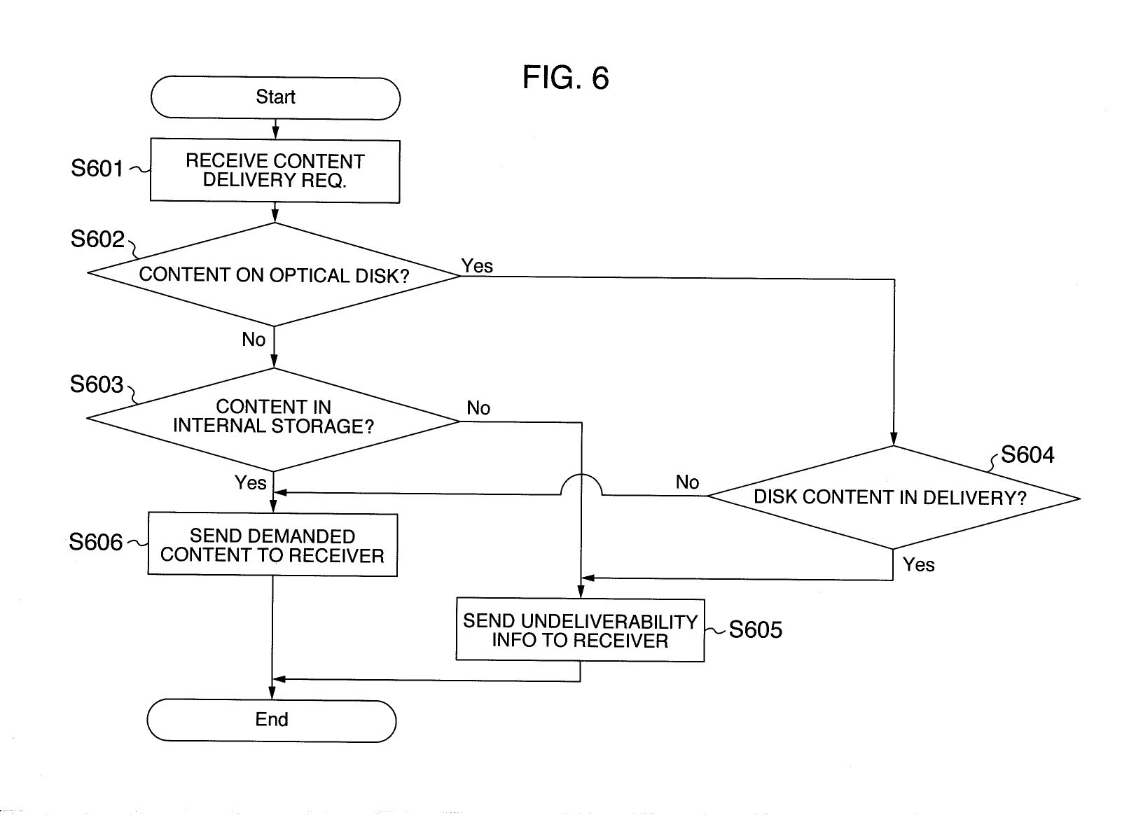

FIG. 6 is a flowchart for detailed explanation of the content delivery processing at the step S302 of FIG. 3.

The content delivery apparatus 100 and content receiver device 103 perform the above-stated authentication processing according to need and share the key information necessary for content encryption and decryption; thereafter, the content delivery apparatus 100 receives a content delivery request from the content receiver device 103 via the network (at step S601).

The content delivery apparatus 100 makes investigation to determine whether the demanded content is one of the contents recorded on the optical disk loaded in the ODD 101 (at step S602).

When a check result of the step S602 indicates that the demanded content is not the content recorded on the optical disk, research is carried out to determine whether the demanded content is one of the contents stored in the built-in record media 102 (step S603). As a result, when the demanded content is not the content stored in the built-in record media 102, information indicating the content delivery incapability is sent to the content receiver device 103 along with the cause of such undeliverability, if needed; then, the processing is terminated (step S605). When the demanded content is the content stored in the built-in record media 102, the procedure goes to step S606.

When the check result at the step S602 indicates that the demanded content is the content recorded on the optical disk, investigation is made to determine which one of the contents recorded on the optical disk loaded in ODD 101 is being delivered to content receiver devices including the content receiver device 103 (step S604). As a result, if any one of the contents recorded on the optical disk is in the process of distribution, then information indicative of the content undeliverability is sent to the content receiver device 103 along with the cause thereof, if needed; then, the processing is terminated (step S605). If the demanded content is not being delivered, the procedure goes to step S606.

In a case where at the steps S603 and S604 the demanded content is either the content stored in the built-in record media 102 or the content recorded on the optical disk which is not being sent for distribution, the demanded content is read out by the storage controller 200, and transmitted by the content transmitter 202 for distribution to the content receiver device 103 that is the source of request through the network communication processor 206 (step S606). Here, the demanded content thus read is transmitted after having transcoded by the transcode processor 207 into a format receivable by the content receiver device 103 or, alternatively, while applying thereto the transcoding processing on an as-needed basis. Additionally, when the demanded content is the content to be copyright-protected, either the readout demanded content or the demanded content which has been applied the transcoding processing or which is in the process of transcoding is transmitted after the demanded content is decrypted by the decrypter 207 based on the key information shared by the authentication processing of the step S601 to have the DTCP-IP standard-compliant form.

In case at the steps S604-S605 any one of the contents recorded on the optical disk is again demanded under the condition that the on-disk content has already been in the process of network distribution, such demanded content will not be distributed in response to receipt of a later-received content delivery request; instead, the content undeliverability information is sent to the content receiver device 103, thereby avoiding repetitive occurrence of seek processing of the optical disk, thus enabling achievement of the operation stability of the currently-executed content distribution processing.

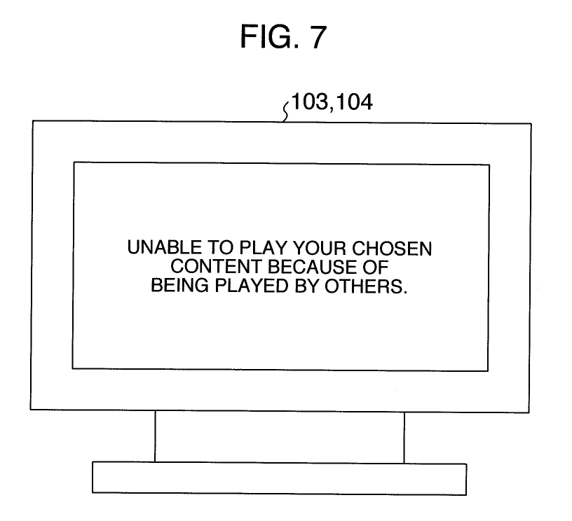

FIG. 7 shows an on-screen display example in cases where the content receiver devices 103 and 104 received the content delivery incapability information from the content delivery apparatus 100. On the display screen of the content receiver devices 103-104, a message notifying the user of the content undeliverability is displayed as shown in the example of FIG. 7. By seeing it, the user is able to know the reason why his or her requested content is not available.

It is noted here that although the step S604 is arranged to determine whether any one of the contents recorded on the optical disk is presently sent for distribution and then send the demanded content to the content receiver device 103 only when the content is not in the process of distribution, there is also employable another method for putting a limit on the number of simultaneous deliverable contents and for transmitting such contents within a range not in excess of this limited number. With this approach, it is possible to realize optimal content distribution best suited to hardware and software performances of the content delivery apparatus 100.

From the foregoing, it is apparent that one characteristic feature of this embodiment lies in transmitting the content recorded on an optical disk loaded into the content delivery apparatus 100 to the content receiver device 103, 104 while letting it be included in the content list. Another feature of the embodiment is that when the content receiver device 103, 104 selects the content recorded on the optical disk from the content list and then issues a content delivery request to the content delivery apparatus 100, the content delivery apparatus 100 verifies whether any one of the contents within the optical disk is being distributed at the present moment and allows distribution of the demanded content if not in the process of distribution. With this arrangement, it is possible for the content receiver device(s) to get BD/DVD-stored contents over the network for user's enjoyment thereof. In addition, it is possible for the content delivery apparatus to prevent repetitive occurrence of the optical disk seek processing and also to execute stability-increased content distribution processing.

Note here that although this embodiment is arranged to issue a content list transmission request or a content delivery request from the content receiver device 103, 104 to the content delivery apparatus 100, this may be modified so that the content list transmission request or the content delivery request is issued from the content delivery apparatus 100 to the content receiver device 103, 104. Additionally, regarding detection of electrical equipments existing on the network, any one of the currently available methods may be used, such as the universal plug-and-play (UPnP) technology and others.

### Embodiment 2

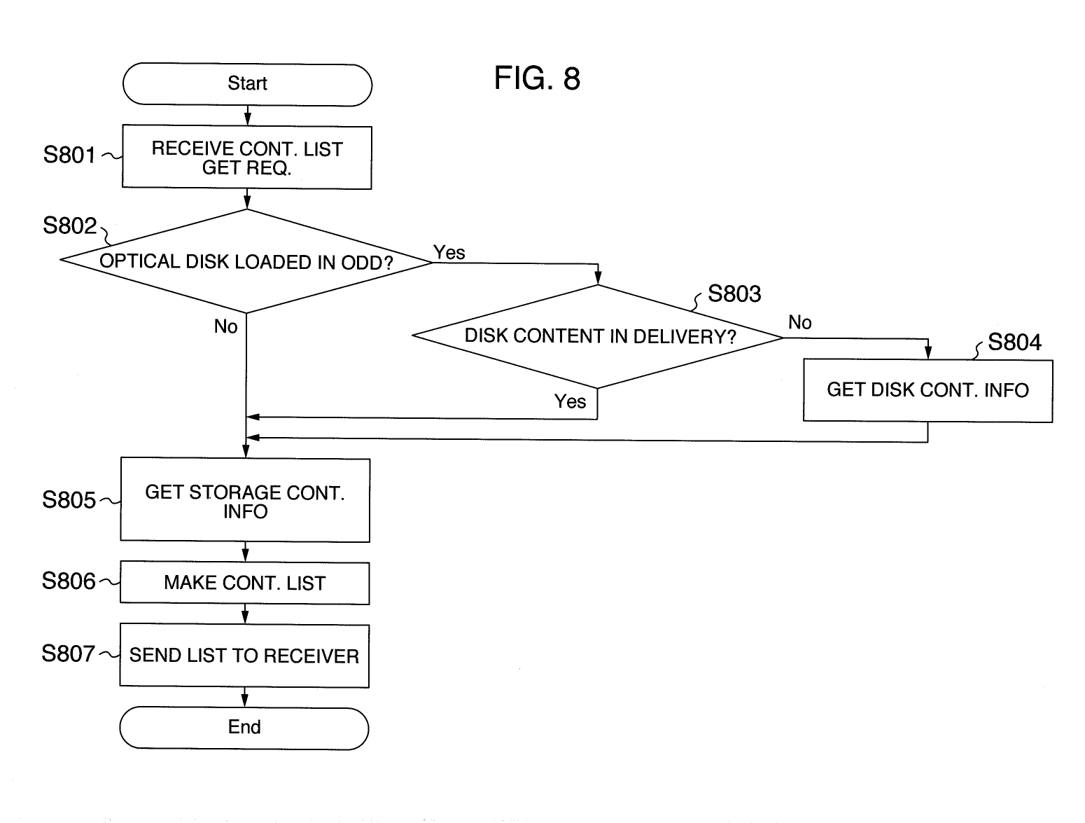

One embodiment showing characteristic features of this invention will be explained with reference to FIG. 8.

FIG. 8 is a flowchart for detailed explanation of the content list generation/delivery processing at the step S301 of FIG. 3.

The content delivery apparatus 100 receives a content list acquisition request from the content receiver device 103 via the network (at step S801).

In responding thereto, the content delivery apparatus 100 checks on the optical disk drive (ODD) 101 to determine whether an optical disk is loaded thereinto (at step S802).

As a result, in a case where any optical disk is not loaded into ODD 101, the system procedure goes to step S805 which collects information as to the contents stored in the built-in record media 102.

On the other hand, in case an optical disk is loaded in ODD 101, investigation is made to determine whether any one of the contents recorded on the optical disk loaded in ODD 101 is being delivered to content receiver devices including the content receiver device 103 (at step S803). If any one of the contents is currently in the process of distribution, then the procedure goes to step S805.

If at the step S803 any one of the contents is not in the process of distribution, an operation is performed to collect the information concerning the contents recorded on the optical disk being set in ODD 101 (at step S804).

After having collected the information as to the contents on the optical disk, an operation is done to collect information as to those contents stored in the built-in record media 102 (at step S805).

Then, based on the information collected at the steps S804 and S805, a content list is generated (at step S806).

Finally, the content list generated is transmitted to the content receiver device 103 or 104 (step S807).

Note here that although the step S803 is arranged to judge whether any one of the contents recorded on the optical disk is being sent for distribution and then send on-disk content information to the content receiver device 103 while letting it be included in the content list only when the same is not in the process of distribution, there is another method for putting a limit on the number of simultaneous deliverability and for transmitting the content information while including it in the content list within the range of not exceeding this limited number.

With the arrangement stated above, it becomes possible, by checking whether the contents recorded on the optical disk are being served to the content receiver device, to include only those contents which are distributable by the content delivery apparatus 100 in the content list, thereby making it possible to avoid the risk of unwanted occurrence of an event that the user's selected content is not available even after having selected his or her favorite content.

### Embodiment 3

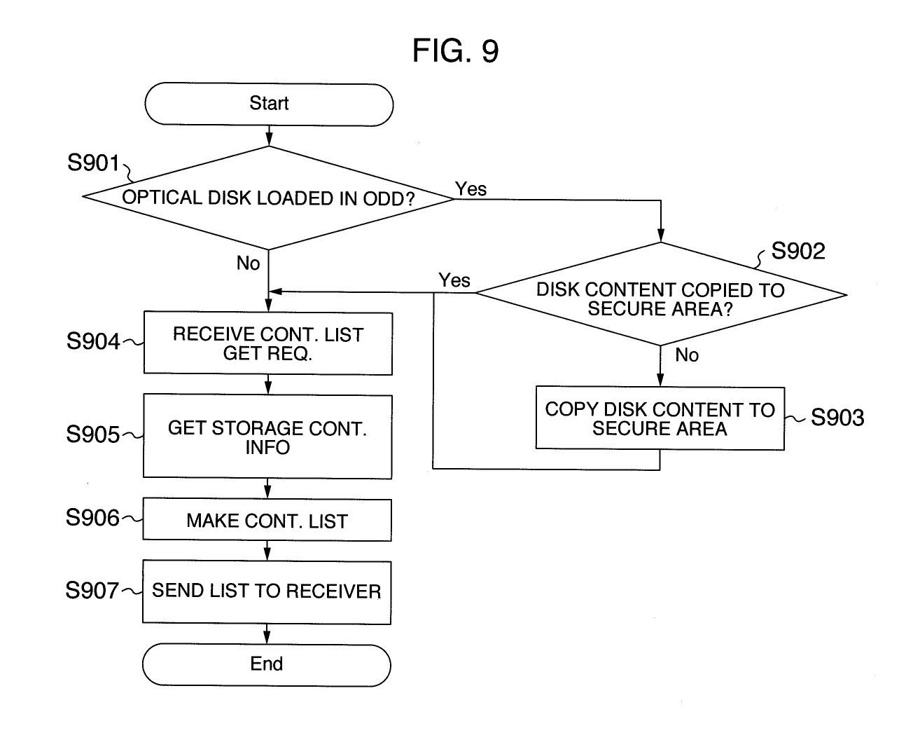

One embodiment showing characteristic features of this invention will be explained with reference to FIGS. 9 to 11.

FIG. 9 is a flowchart showing in detail the content list generation/delivery processing at the step S301 of FIG. 3.

The content delivery apparatus 100 checks on the optical disk drive (ODD) 101 to determine whether an optical disk is presently loaded thereinto at a predetermined timing, such as upon startup of the system or a specific software program or, alternatively, at a time point designated by the user (at step S901).

If no optical disk is loaded into ODD 101, then the procedure goes to step S904.

On the other hand, when an optical disk is loaded into ODD 101, investigation is made to determine whether the contents recorded on the optical disk being set in ODD 101 have been copied to the secure area 208 within the built-in record media 102 (at step S902). When the contents on the optical disk have already been copied to the secure area 208, the procedure goes to step S904. In case the on-disk contents have not been copied to the secure area 208, an operation is performed to copy the contents of the optical disk loaded in ODD 101 to the secure area 208 in the built-in record media 102 (step S903). Here, at this step S903, a decision is made as to whether the on-disk contents are contents to be copyright-protected; in case these contents are encrypted by AACS, CPRM or CSS scheme, the storage controller 200 decrypts the contents when reading out of the optical disk and further re-decrypts the contents by AACS, CPRM or CSS scheme or by its unique decryption method during writing into the secure area. The decryption method used in the process of writing into the secure area may be the same scheme as that used for the contents recorded on the optical disk or, alternatively, may be modified on a case-by-case basis. Additionally, the decryption information used when writing into the secure area is managed by using another area (e.g., record media or partition) different from the content-recording secure area; desirably, the information is encrypted by a different encryption scheme from that of the contents. Optionally, in case at the step S903 the contents are those without the need for copyright protection, a method is employable for copying them to a storage area other than the secure area.

Next, after having completed full copy to the secure area or copy of a prespecified size of content at the step S903, when the content delivery apparatus 100 receives a content list acquisition request from the content receiver device 103 or 104 via the network (at step S904), an operation is performed to collect the information as to the contents stored in the built-in record media 102 (at step S905). In this event, regarding the contents that have been copied to the secure area 208 also, information collection is performed in a similar way.

Then, based on the information collected at the step S905, a content list is generated (at step S906). Finally the content list is sent to the content receiver device 103 or 104 (step S907).

With the above-stated procedure, it is possible, by copying the contents recorded on the optical disk to the secure area 208 at step S903, to read the demanded content from the secure area without having to directly read it from the optical disk when on-disk content distribution is requested from the content receiver devices 103 and 104 simultaneously. In this case, when the contents saved in the secure area are decrypted contents, the above-stated authentication processing is performed where necessary, followed by sharing of key information between the content delivery apparatus 100 and content receiver device 103, 104 only when the authentication processing was succeeded. And, the storage controller 200 decrypts again the encrypted contents and uses the key information to perform encryption and format conversion in the DTCP-IP-compliant way and then transmits the resulting contents. In this event, it is possible to prevent occurrence of seek processing, which is the cause of a decrease in transmission rate occurring in cases where distribution of the on-disk contents is requested from two or more content receiver devices at a time.

Additionally, by writing the encrypted contents into the secure area 208, the contents saved in the secure area are no longer readable by users and software programs other than specific software even when the contents recorded on the optical disk are the contents to be copyright-protected; thus, it is possible to prevent unauthorized copy and defend the right of an owner(s) of the copyright to the contents.

Note that in cases where the content delivery apparatus 100 is required to distribute the copyright-protected contents saved in the secure area to a plurality of content receiver devices simultaneously, there is also employable a method for modifying the key information shared in the process of authentication processing to have different contents on a per-receiver basis.

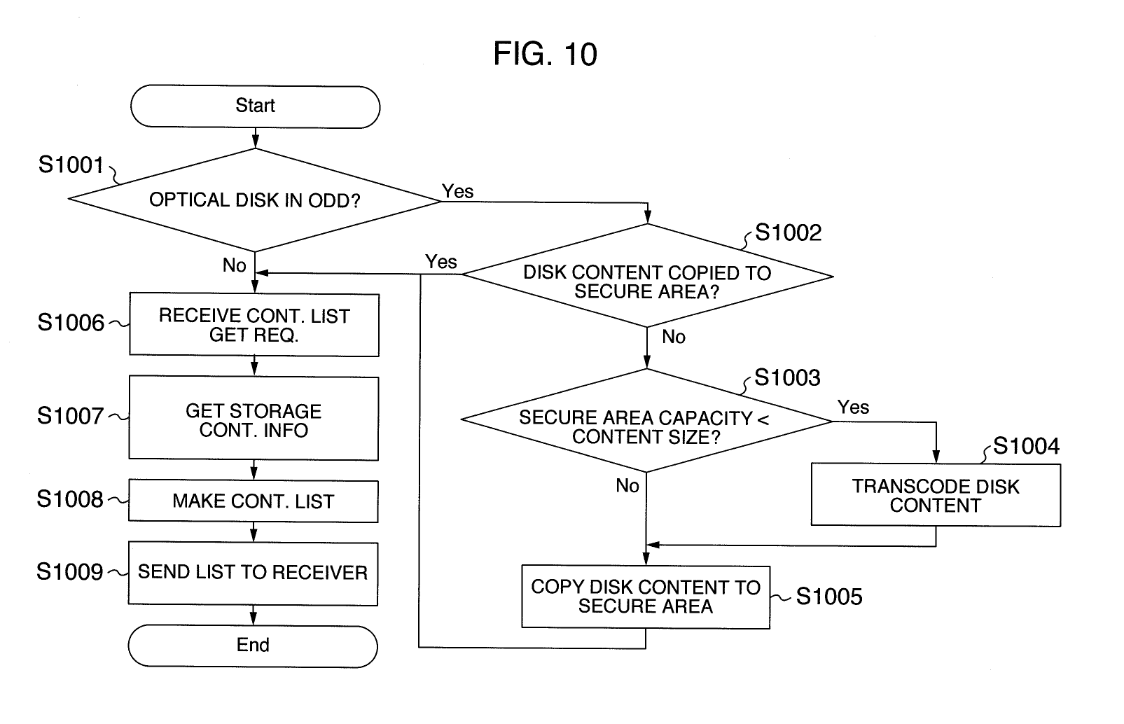

FIG. 10 is also a flowchart showing in detail the content list generation/distribution processing at the step S301 of FIG. 3.

In step S1001, the content delivery apparatus 100 performs investigation to determine whether an optical disk is presently loaded into ODD 101. If no optical disk is loaded in ODD 101, then the procedure goes to step S1006. On the other hand, if an optical disk is loaded in ODD 101, the procedure goes to step S1002 which makes investigation to determine whether the contents recorded on the optical disk being set in ODD 101 have been copied to the secure area 208 in the built-in record media 102 (at step S1002). In case the contents on the optical disk have already been copied to the secure area 208, the procedure goes to step S1006. In case the on-disk contents are not copied to the secure area 208, an operation is performed to compare a remaining storage capacity of the secure area with the file size of the on-disk contents (at step S1003). When the remaining storage capacity of secure area is less than the file size of disk contents, the procedure goes to step S1004. At step S1004, the transcode processor 207 performs transcoding processing in order to provide a file size which is less than the original contents recorded on the optical disk being set in ODD 101; then, the procedure goes to step S1005. Examples of the transcode processing for reducing the file size include conversion to compression scheme for achieving higher compression rate, bit rate conversion and downscaling. At step S1004, in case the remaining storage capacity of secure area is greater than the on-disk content file size, the procedure goes to step S1005 without performing the transcode processing. At step S1005, the contents are copied to the secure area 208 within the built-in record media 102, followed by transition to step S1006. At step S1005, when the contents are those with no need for copyright protection, a method for copying such contents to a storage area other than the secure area may be used. At step S1006, a content list acquisition request is received via the network from the content receiver device 103 or 104. Subsequently, at step S1007, information is collected concerning the contents stored in the built-in record media 102. In this event, content information is also collected also concerning the transcoded contents that have been copied within the secure area 208. Subsequently, at step S1008, a content list is generated based on the information collected at the step S1007. Lastly, at step S1009, the content list is transmitted to the content receiver device 103 or 104.

With the above-stated procedure, it is possible by reducing the file size through the transcoding of original contents recorded on the optical disk at step S1004 to lessen the required capacity of the secure area, thereby making it possible to effectively use the storage capacity of the built-in record media 102. In addition, by reduction of the file size of contents, it is possible to lessen the traffic of the network when sending for distribution the contents to the content receiver devices 103 and 104 via the network, thereby enabling more stable playback thereof. Additionally, by copying contents to the secure area 208, it is possible, upon receipt of requests for distribution of the contents on the optical disk from both of the content receiver devices 103 and 104 at a time, to read the demanded contents out of the secure area without having to read them directly from the optical disk. In this case, it is possible to prevent occurrence of the seek processing, which is the cause of a decrease in transfer rate occurring in cases where distribution of the on-disk contents is requested from a plurality of content receiver devices.

Note here that although in the embodiment stated supra the operation is performed in step S1003 to compare the remaining storage capacity of the secure area to the file size of contents recorded on the optical disk and perform, when the remaining capacity of secure area is smaller than the on-disk content size, the transcoding of such contents at step S1004, there is another method for performing the transcoding depending on the user's mode setup, the type of content receiver devices 103-104 (such as mobile terminals, cellular phones, or else) and/or access conditions (e.g., access from the outside of home, the use of a low-quality communication line, etc.).

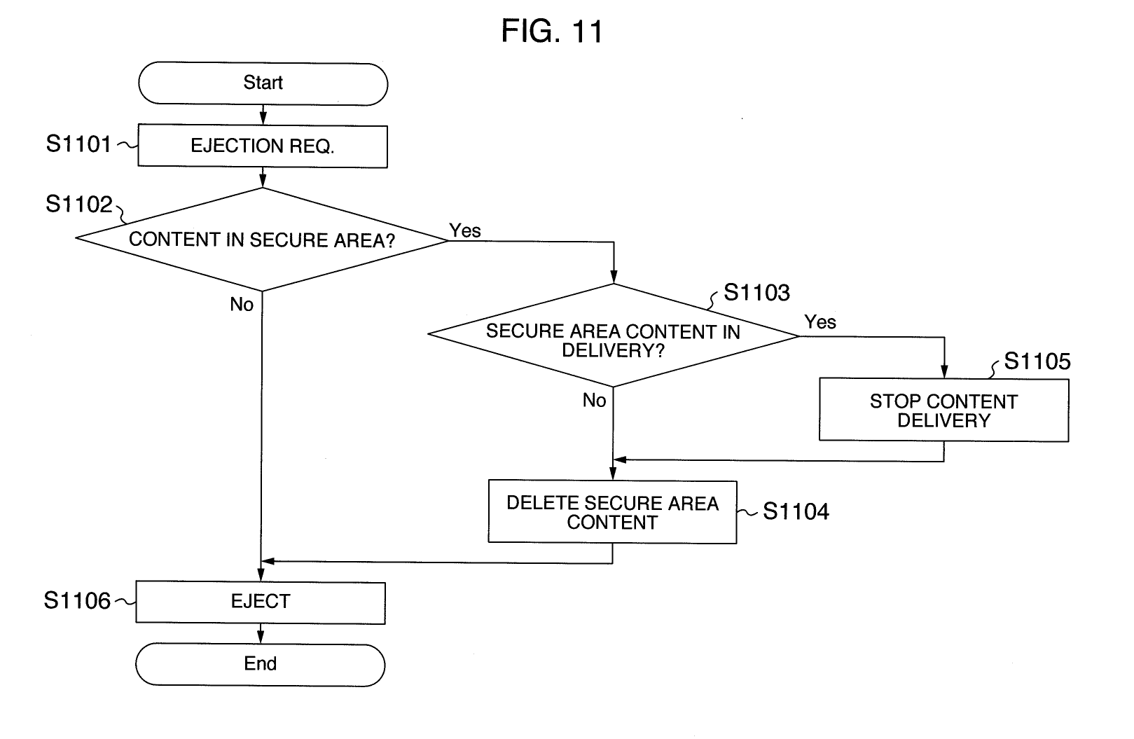

FIG. 11 is a flowchart of the user's operation for unloading the optical disk loaded in ODD 101. At step S1101, the ODD 101 receives from the user an optical disk ejection request. Subsequently at step S1102, investigation is made to determine whether contents are present in the secure area 208 within the built-in record media 102. If there are contents in the secure area 208, the procedure goes to step S1103 which performs investigation to determine whether the contents in secure area 208 are being distributed to the content receiver devices 103 and 104. If not in the process of distribution, go to step S1104 which deletes the contents in the secure area 208, and then go to step S1106. In case the contents in secure area 208 are being delivered to the content receiver devices 103-104 at step S1103, go to step S1105 which stops the content delivery, followed by transition to step S1104 which deletes the contents in secure area 208.

On the other hand, in case no contents are found in the secure area 208 at step S1102, the procedure goes to step S1106 which executes disk ejection processing for taking the optical disk out of ODD 101.

With the foregoing procedure, in case the contents existing in the secure area 208 are copies of contents to be copyright-protected, deletion of the contents stored in the secure area 208 at step S1104 makes it possible to erase the copies, thereby enabling secure attainment of copyright protection. As the secure area-stored contents cannot be read out by users, the intended copyright protection is achievable without execution of the copy deletion; however, by reliably erasing the contents no longer required, it is possible to prevent unauthorized copy, thereby making it possible to certainly defend the right of a copyright owner(s) of the contents.

In case the secure area-saved content is in the process of distribution at step S1103, the disk ejection may be prevented until completion of the content distribution.

To erase the contents of the secure area without fail, such secure-area content erasure may be performed in an automated way in cases where no access is provided thereto for a predetermined length of time.

### Embodiment 4

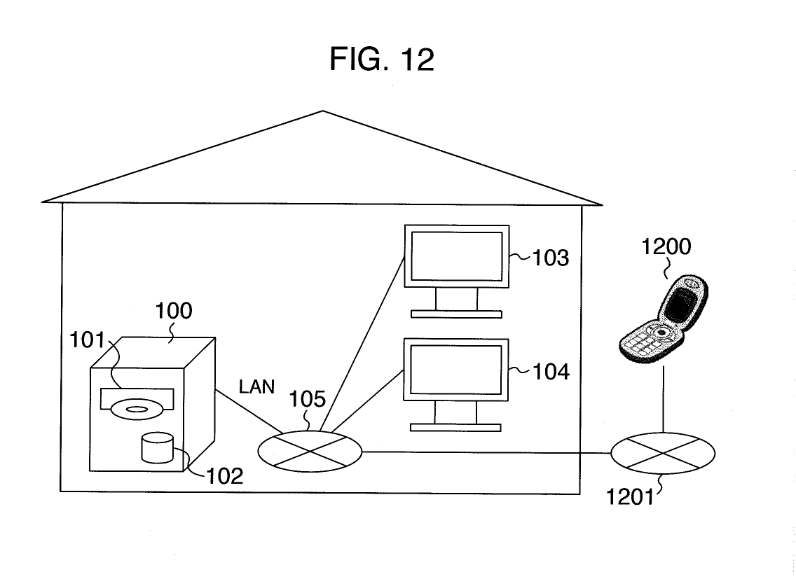

One embodiment showing characteristic features of this invention will be explained using FIGS. 12 to 14.

This embodiment is an example which permits a user to download via the Internet, for enjoyment, any one of the contents stored in content delivery apparatus by using a content receiver device, such as a cellular or “mobile” telephone handset or else, when the user is out of home.

FIG. 12 shows an entire system configuration including the in-home network environment of FIG. 1, to which are added a cellular telephone 1200 and Internet 1201, wherein the cellular phone provides remote access thereto from any places outside the user's home, such as his or her visiting site, friend's house, etc. The cellular phone 1200 is communicable via Internet 1201 with the content delivery apparatus 100 that is linked to the in-home network. The cellular phone 1200 is a type of information equipment capable of requesting the content delivery apparatus 100 to send playback content and reproduces the content received from the content delivery apparatus 100 in a similar way to the content receiver devices 103 and 104 stated supra.

The Internet 1201 is arranged, like LAN 105, to use standard Internet protocol (IP) as its network protocol and use the transmission control protocol (TCP) and user datagram protocol (UDP) for upper-level transport protocols. For content transfer, further upper-level application protocols are used, such as real-time transport protocol (RTP), hypertext transfer protocol (HTTP) and file transfer protocol (FTP). The IP has different versions, i.e., IPv4 and IPv6, any one of which is employable. Additionally, the cellular phone 1200 is linked via a hub, router and various types of server devices, although these are not specifically shown in FIG. 12.

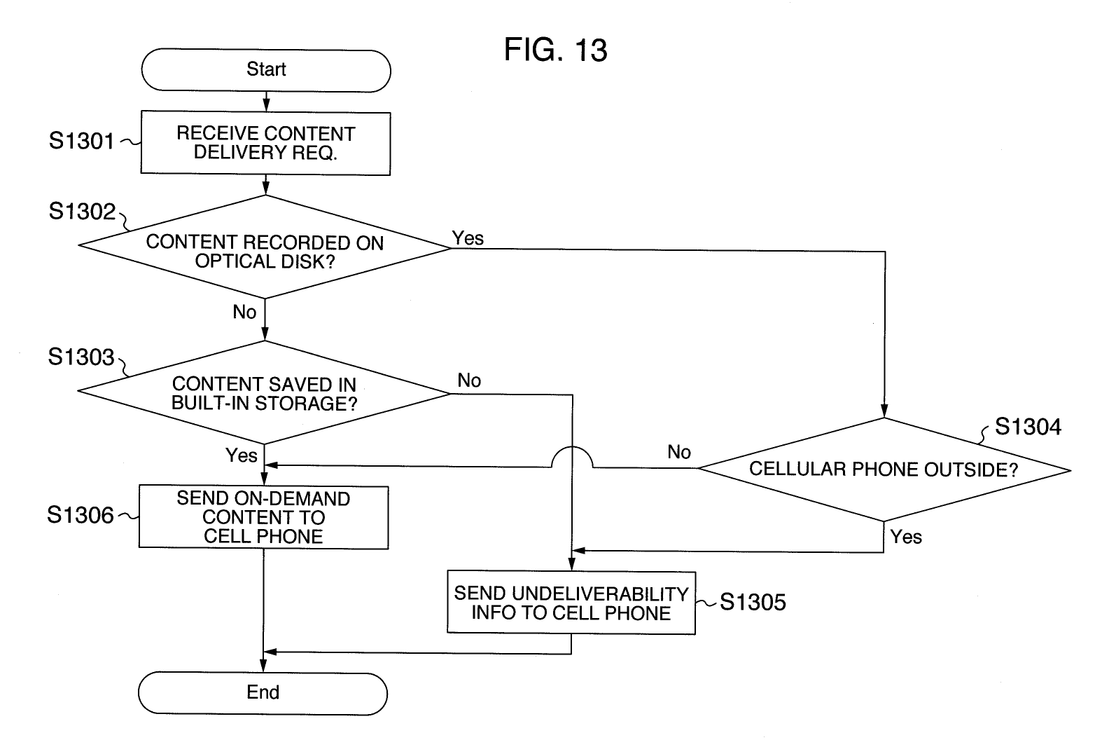

FIG. 13 is a flowchart showing in detail the content delivery processing in the step S302 of FIG. 3.

The content delivery apparatus 100 and cellular phone 1200 execute either the above-stated authentication processing or predefined remote access-use authentication processing when the need arises and share the key information necessary for content encryption/decryption; thereafter, the content delivery apparatus 100 receives a content delivery request from the cellular phone 1200 via the Internet 1201 (at step S1301).

The content delivery apparatus 100 makes investigation to determine whether the user's demanded content is any one of the contents that are recorded on an optical disk loaded into the optical disk drive (ODD) 101 (at step S1302).

In case a result of the checking at the step S1302 indicates that the demanded content is not the content recorded on the optical disk, investigation is made to determine whether the demanded content is the one stored in the built-in record media 102 (at step S1303). When a result of it indicates that the demanded content is not stored in built-in record media 102, information indicating the content undeliverability is sent to the cellular phone 1200 along with the cause of such undeliverability if needed; then, the processing is ended (at step S1305). In case the demanded content is stored in the built-in record media 102, the procedure goes to step S1306.

In case the checking result at step S1302 indicates that the demanded content is the one recorded on the optical disk, an operation is performed to determine whether the cellular phone 1200 is in the user's home or in outdoor locations (at step S1304). If the cell phone 1200 is in outdoor or “out-home” environments, the information indicating the content undeliverability and the cause of such incapability, if needed, are sent to the cell phone 1200, followed by termination of the processing (at step S1305). If the cell phone 1200 is in indoor or “in-home” environments, the procedure goes to step S1306.

The determination as to whether the cell phone 1200 is currently in home or out of doors may be done by several methods including a method for allowing the content delivery apparatus 100 to make a decision based on whether the authentication processing executed between the content delivery apparatus 100 and cell phone 1200 is for the indoor-use or outdoor-use, a method for measuring the length of a time taken up to the issuance of a response of the cell phone 1200 with respect to the information as sent from the content delivery apparatus 100 and for making judgments with a predetermined time as threshold value, and a method for determining whether the IP address of received packets is a local address or not. Note that in this embodiment, the above-stated judgment processing is performed by the authenticator 203 or the network communication processor 206.

In a case where at the steps S1303 and S1304 the user's demanded content is the one stored in the built-in record media 102 or, alternatively, when the cell phone 1200 stays indoors, the demanded content is read out by the storage controller 200, transmitted by the content transmitter 202, and then transmitted to the cell phone 1200 that is the source of request through the network communication processor 206 (at step S1306). Here, the demanded content thus read out is transmitted after having been transcoded by the transcode processor 207 into an appropriate form receivable by the cell phone 1200 or while being simultaneously transcoded on an as-needed basis. Additionally, when the demanded content is copyright-protected, either the readout demanded content or the transcoded/during-transcoding demanded content is encrypted by the decrypter 207 based on the key information shared by the authentication processing of the step S1301 in the DTCP-IP-compliant form and then transmitted to the cell phone 1200.

In case the cell phone 1200 is indoors at the steps S1304 and S1305, the content delivery apparatus 100 does not deliver the demanded content in response to receipt of the content delivery request but transmits the content delivery incapability information to the cell phone 1200, whereby it is possible when the demanded content is copyright-protected to prevent unauthorized copy, thereby reliably defending the right of a copyright owner(s) of such content.

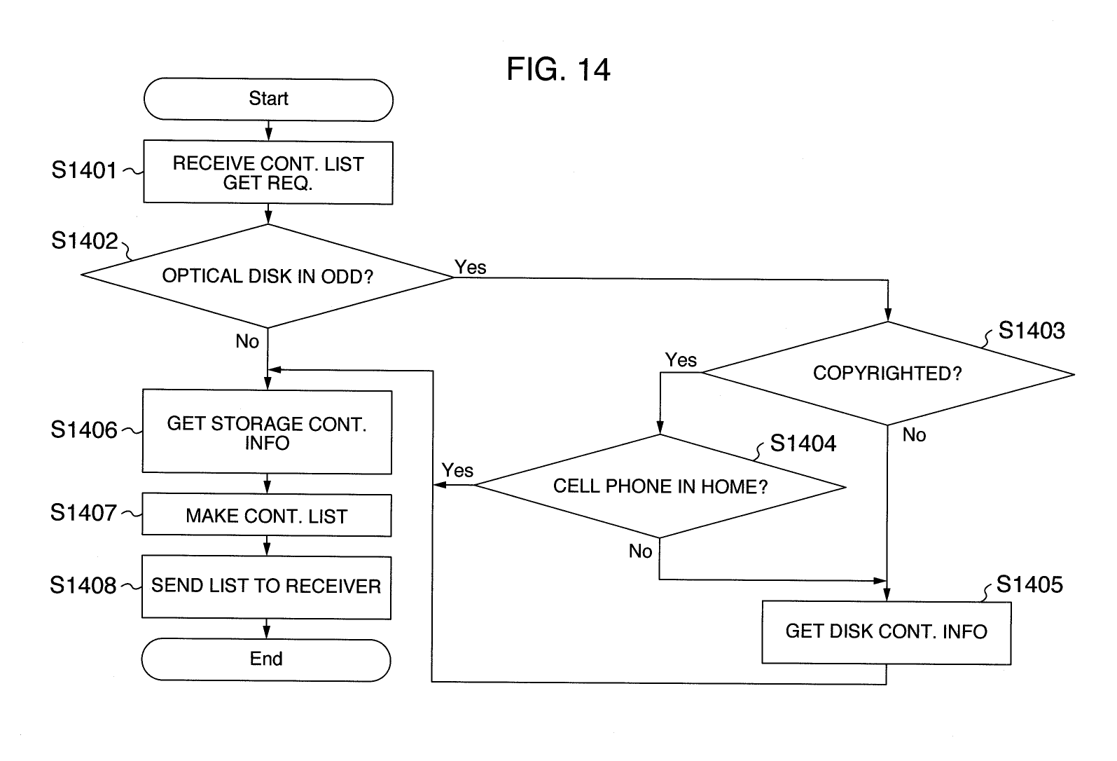

FIG. 14 is a flowchart showing in detail the content list generation/distribution processing of the step S301 of FIG. 3.

The content delivery apparatus 100 receives a content list acquisition request from the cellular phone 1200 via the Internet (at step S1401).

In responding thereto, the content delivery apparatus 100 checks on the ODD 101 to determine whether an optical disk is loaded thereinto (at step S1402).

When a check result indicates that no optical disk is loaded into ODD 101, the procedure goes to step S1405 which collects information as to contents stored in the built-in record media 102.

On the other hand, in case an optical disk is loaded into ODD 101, the procedure proceeds to step S1403 which determines whether or not the contents recorded on the optical disk are contents to be copyright-protected. If the contents on the optical disk are not the copyright-protected contents, the procedure goes to step S1405. If the on-disk contents are copyright-protected contents, go to step S1404 which makes investigation to determine whether the cellular phone 1200 is in out-home or in-home environments. If the cell phone 1200 is currently indoors, i.e., stays in the user's home, go to step S1405 which collects information concerning the contents recorded on the optical disk loaded in ODD 101. When the cell phone 1200 is outdoors, i.e., outside the house, the procedure jumps to step S1406.

As the technique for determining whether the contents recorded on the optical disk are the copyright-protected contents or not, there is a method for making reference to copy control information (CCI) involved in the contents. In case such CCI is not found therein, the contents are treated as contents with no need for copyright protection.

In step S1406, an operation is performed to collect information as to the contents stored in the built-in record media 102.

Then, the information collected at the steps S1405-1406 are used to generate a list of contents (at step S1407).

Finally the content list is transmitted to the cell phone 1200 (step S1408).

With the procedure stated above, in cases where the contents recorded on the optical disk are copyright-protected contents and, simultaneously, the cellular phone 1200 is outdoors, the content list is specifically created so as to exclude the optical disk contents, whereby it is possible to prevent unauthorized copy of the copyright-protected contents, thus making it possible to defend the rights of copyright holders of such contents. In addition, the disk contents are not accessible for selection from the cell phone 1200; so, it is possible to avoid occurrence of an event that the user cannot enjoy his or her favorite content even after having selected it. In this embodiment, one specific content delivery apparatus has been set forth, which is arranged to include, when the cellular phone 1200 is indoors, the contents recorded on the optical disk in the content list without regard to whether these are copyright-protected contents or contents without the need for copyright protection and, when the cell phone 1200 is outdoors, exclude the copyright-protected contents from the content list and include the contents without the need for copyright protection in the content list. Optionally, the copyright-protected contents may be displayed in the form of a list of non-selectable contents after having included them in the content list. On the other hand, another implementation method may be used which permits, when the cell phone 1200 is outdoors, certain ones of the copyright-protected contents recorded on the optical disk—e.g., the contents of digital broadcast programs that are privately recorded by home-use video recorder equipment—to be included in the content list and prevents prerecorded contents on sell-out BDs or DVDs, such as motion pictures, concert videos, etc., from being included in the content list. Determining whether the content of interest is a privately recorded digital broadcast program or sellout disc content is achievable based on evaluation of the kind of a record media used therefor. For example, in the case of DVDs, digital broadcast programs are recorded on DVD−R, DVD−RW, DVD+R, DVD+RW or DVD-RAM whereas sell-DVD contents are on DVD-ROMs only. In the case of BDs, digital broadcast programs are recorded on BD-R or BD-RE; sell-BDs are BD-ROMs only.

From the foregoing, in cases where the contents recorded on the optical disk are sell-BD/DVD contents and the cellular phone 1200 is in out-home environments, such contents are not included in the content list whereby it is possible to deter illegal duplication of the copyright-protected contents, thus making it possible to reliably defend the right of the copyright owner(s) of such contents. In addition, since the on-disk contents are not selectable from the cell phone 1200 in any way, it is possible to avoid occurrence of an event that the user cannot enjoy his or her favorite content even after having selected it. Furthermore, since those digital broadcast program contents recorded by home-use video recorders are involved in the content list, an advantage is obtained as to an increase in number of viewable/listenable contents for the user of cell phone 1200. Furthermore, in case the cell phone 1200 is outdoors, the sell-BD/DVD contents that have been copied to the built-in record media 102, such as HDD, by using the so-called “managed copy” may also be prevented from being included in the content list. The managed copy is a set of standards for enabling an optical disk drive-containing apparatus to copy sell-BD/DVD contents through execution of authentication with an external server existing on the Internet. Judgment of the duplicated contents using the managed-copy scheme may be done by a method for embedding in copy destination content per se the flag information indicative of managed copy-based duplication during copying. For instance, if the copy destination content is a movie data file compliant with MPEG2-SYSTEM standards, the flag information may be embedded in a descriptor region of program map table (PMT) packet. Alternatively, similar results are also obtainable by another method for providing specific information indicating that the managed copy has been performed as content management information in addition to the copy destination contents per se.

From the foregoing, in case the cell phone 1200 is outside the user's home, the sell-BD/DVD contents that have been duplicated using the managed-copy scheme are prevented from being included in the content list whereby it is possible to prevent illegal copying of the copyright-protected contents, thus making it possible to reliably protect the right of the copyright owner of such contents.

It is noted that this invention should not exclusively be limited to the above-stated illustrative embodiments; various modifications and alterations are included therein. For example, the embodiments stated above are the ones for clear and detailed explanation of this invention and are not to be construed as limiting the invention. A part of the configuration of one embodiment is replaceable with a configuration of another embodiment; in addition, the configuration of an embodiment is addable to the configuration of another embodiment. It is also permissible, regarding one part of the configuration of each embodiment, to perform addition, deletion or replacement of another configuration.

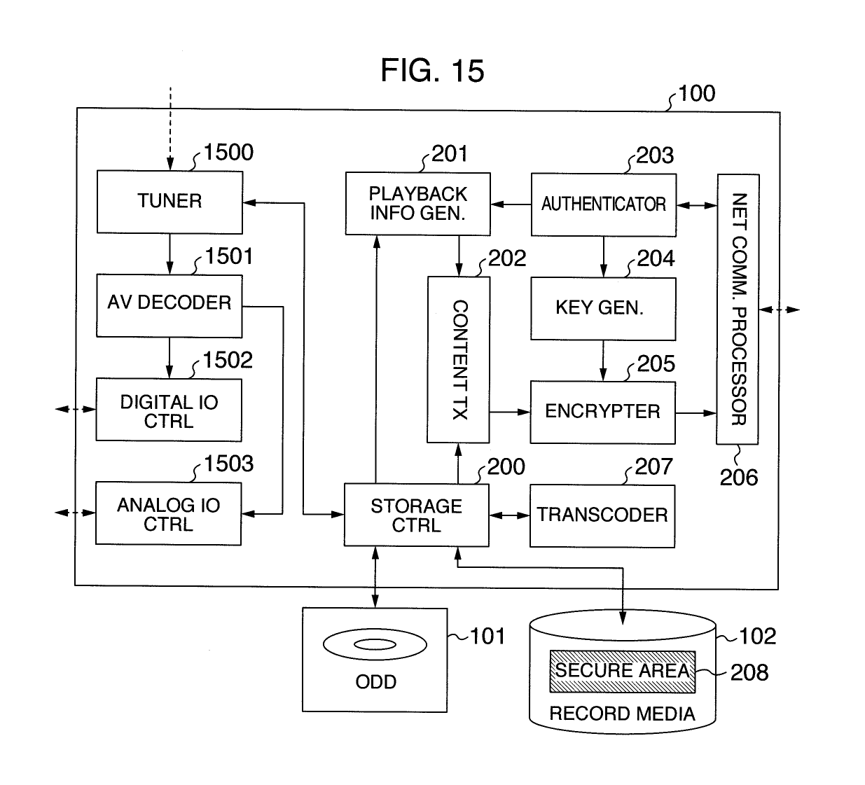

For instance, the configurations of the home network, content delivery apparatus and content receiver devices of the embodiment 1 shown in FIGS. 1 and 2 and those of the embodiment 4 shown in FIG. 12 are examples only, and the invention should not be limited to arrangements of these components. For example, FIG. 15 is a drawing in the case of expanding the content delivery apparatus 100 of FIG. 2 while assuming the use of TV with built-in storage. The content delivery apparatus 100 has a tuner 1500, video-audio decoder 1501, digital input/output control unit 1502 and analog input/output control unit 1503 in addition to the configuration shown in FIG. 2.

The tuner 1500 receives a digital broadcast wave, decodes it into a format inputtable to the video/audio decoder 1501, and inputs it to the video/audio decoder 1501. Examples of the format inputtable to the video/audio decoder 1501 include MPEG2 and H.264. The tuner is connected to the storage control unit 200; so, it is also possible to record broadcast contents on an optical disk being loaded into the optical disk drive (ODD) 101 or store them in the built-in record media 102. The video/audio decoder 1501 decodes the video/audio data as received from the tuner 1500 and reproduces for visual display on the screen of a display device, which is connected through the digital input/output controller 1502 or the analog input/output controller 1503. The digital input/output controller 1502 has supportability and compatibility with multiple cable/terminal standards, such as HDMI, DVI, etc. The analog input/output controller 1503 supports several cable/terminal types, such as RCA terminal, D terminal, etc.

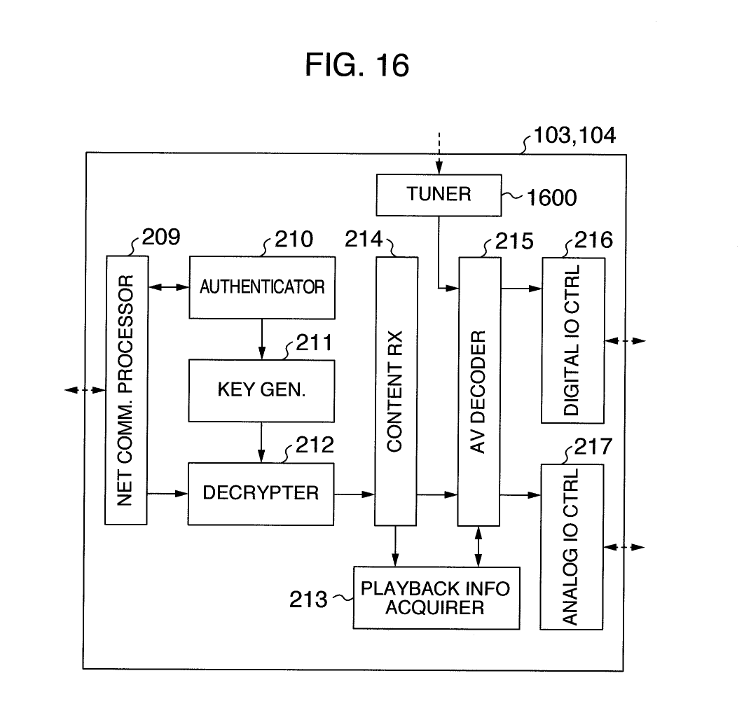

FIG. 16 is a diagram in the case of expanding the content receiver devices 103 and 104 of FIG. 2 while assuming the use of TV in a similar manner to FIG. 15. Content receiver devices 103-104 are each arranged to have a tuner 1600 in addition to the configuration shown in FIG. 2. The functionalities of respective constituent components or elements are the same as those shown in FIG. 15. Note here that in each of the above-stated embodiments one exemplary technique is used for distinguishing authorized users over unauthorized users based on judgment as to whether a content receiver device functioning as the source of a request is currently in the user's home or out of home, it is also possible to grant copyright-protected content list displaying and distribution even when the device is indoors as far as its owner is a truly authorized user. On the other hand, when taking into consideration architectural structures such as buildings, it is also possible to limit unauthorized users' copyrighted content list display and distribution even when they are in the same site. For determining whether the person of interest is an authorized user or not, a method different from that of the aforesaid embodiment is used—for example, a password authentication method or the like.

Also note that the on-screen display examples used for content receiver device shown in FIGS. 5 and 7 are mere examples only, and these display contents are not to be construed as limiting the invention. The configurations and display examples may be modifiable without departing from the spirit and scope of the invention. In addition, the flowcharts of the embodiments 1 to 4 shown in FIGS. 3-4, 6, 8-11 and 13-14 are examples only and are not to be construed as limiting the processing contents. These processes may be modified in number of processing steps and in sequence thereof without departing from the subject matter of the invention as disclosed herein.

It should be further understood by those skilled in the art that although the foregoing description has been made on embodiments of the invention, the invention is not limited thereto and various changes and modifications may be made without departing from the spirit of the invention and the scope of the appended claims.

1. A content list and content delivery apparatus for sending a content list and contents over a network said apparatus comprising:
an optical disk device capable of reproducing the contents;
a record media capable of recording the contents, said record media excluding optical disks;
content list generation/transmission means responsive to a content list acquisition request to be sent from a content receiver device connected via the network, for generating and transmitting a list of contents recorded on an optical disk being set in the optical disk device and also stored in the record media other than the optical disk; and
content delivery means responsive to a content delivery request to be sent from the content receiver device, for searching a corresponding content from within the optical disk being set in the optical disk device and the record media other than the optical disk and for delivering it to the content receiver device, wherein
upon receipt of the content delivery request as sent from the content receiver device, in cases where the content requested is a content recorded on the optical disk and, simultaneously, said content receiver device does not exist in the same building as that of the content delivery apparatus, content delivery responding to the content delivery request is not performed.

2. The content list and content delivery apparatus according to claim 1, wherein in the case of reception of the content list acquisition request to be sent from said content receiver device, when an optical disk with copyright-protected contents being recorded thereon is loaded into said optical disk device and when said content receiver device does not exist in the same building as that of the content delivery apparatus, the content list to be generated by said content list generation/transmission means is prepared not to contain therein the copyright-protected contents recorded on the optical disk or, alternatively, in a manner that users are unable to select the copyright-protected contents recorded on the optical disk.

3. A content list and content delivery method for causing a content delivery apparatus, which delivers contents recorded on an optical disk over a network, to distribute a content list and contents to a content receiver device connected via the network, said method comprising:
a content list generation/distribution step of being responsive to a content list acquisition request to be sent from said content receiver device and generating and delivering a list of contents existing on an optical disk loaded in an optical disk device and also existing in a record media excluding the optical disk; and
a content distribution step of searching, in response to a content delivery request to be sent from said content receiver device, a corresponding content from within the optical disk loaded in said optical disk drive and the record media excluding the optical disk, and then delivering the content to said content receiver device, wherein
the content list generation/distribution step includes,
an optical disk presence/absence check step of checking on said optical disk device to determine whether an optical disk is set therein,
an optical disk content information acquisition step of acquiring information of contents recorded on the optical disk, and
a content list generation step of collecting information on contents stored in the content delivery apparatus and making a list thereof, wherein
the content distribution step includes,
a demanded content record media check step of investigating a record media of the content demanded from said content receiver device, and
a content receiver device position check step of checking whether said content receiver device exists in the same building as that of said content delivery apparatus, and wherein said method further comprises:
acquiring, when it is detected at the optical disk presence/absence check step that the optical disk is set in said optical disk device, information of contents recorded on the optical disk at the optical disk content information acquisition step to add at the content list generation step the optical disk content information to the content list for transmission to said content receiver device;
thereafter, when it is determined by the demanded content record media check step that the demanded content from said content receiver device is a content recorded on the optical disk, and further, when it is judged by the content receiver device position check step that said content receiver device exists in the same building as that of said content delivery apparatus, sending for distribution the content on the optical disk to the content receiver device; and
when it is judged by the content receiver device position check step that said content receiver device does not exist in the same building as that of said content delivery apparatus, preventing distribution of the content on the optical disk to said content receiver device.

4. The content list and content delivery method according to claim 3, further comprising a copyright protection information acquisition step of acquiring copyright protection information of the contents recorded on the optical disk, wherein
in cases where it is detected at the optical disk presence/absence check step in said content list generation/distribution step that the optical disk is set in said optical disk device and further it is judged by the copyright protection information acquisition step that the contents recorded on the optical disk are out of copyright protection, the information of contents on the optical disk is included in the content list; and
in cases where it is judged by the copyright protection information acquisition step that the contents on the optical disk are copyright-protected contents, the information of contents on the optical disk is included in the content list when it is judged by the content receiver device position check step that said content receiver device exists in the same building as that of said content delivery apparatus, and
when it is judged by said content receiver device position check step that said content receiver device does not exist in the same building as that of said content delivery apparatus, the information of contents on the optical disk is prevented from being included in the content list or, alternatively, a content list is prepared in such a manner as to disable users to select the contents recorded on the optical disk.
